(19) United States
(12) Patent Application Publication
(10) Pub. No.: US 2010/0053743 A1
(43) Pub. Date: Mar. 4, 2010

(54) APPARATUS FOR REAL-TIME THREE-DIMENSIONAL LASER SCANNING MICROSCOPY, WITH DETECTION OF SINGLE- AND MULTI-PHOTON FLUORESCENCE AND OF HIGHER ORDER HARMONICS

(76) Inventors: Massimo Galimberti, Turbigo (IT); Francesco Saverio Pavone, Firenze (IT)

Correspondence Address: GIFFORD, KRASS, SPRINKLE,ANDERSON & CITKOWSKI, P.C, PO BOX 7021, TROY, MI, 48007-7021, US

(21) Appl. No.: 12/373,560

(22) PCT Filed: Jul. 13, 2006
(86) PCT No.: PCT/EP06/64224

§ 371 Date: Jan. 13, 2009

(51) Int. Cl. G02B 21/06; G02B 26/10; G01D 5/30

(52) U.S. Cl. 359/385; 359/201.2; 250/235

(57) ABSTRACT

Apparatus for real-time three-dimensional laser scanning microscopy, where single-photon fluorescence light, multi-photon fluorescence light, and higher order harmonics generated in the sample are detected. The excitation light is focused into the sample in a three-dimensional matrix of focal points. Real-time three-dimensional image acquisition is obtained by fast scanning in the xy plane only.

### FIELD OF THE INVENTION

The present invention belongs to the field of laser scanning microscopy.

### BACKGROUND

Fluorescence microscopy is a widely diffused technique and has become an essential tool in several scientific research areas, such as biology, biomedicine, and material science. In biology, confocal laser scanning microscopes have become paramount. These microscopes feature optical sectioning of the specimen, thus allowing three-dimensional imaging. In confocal microscopes the illuminating laser beam is focused to a point inside the sample. Fluorescence is excited throughout the whole illuminated volume, but a spatial filter (a pinhole) allows only the fluorescence signal coming from the focal plane to reach the detector. The laser beam scans the sample, and the fluorescence signal is acquired point by point.

Although confocal microscopes have much better axial resolution than widefield fluorescence microscopes, the volume globally excited during a scan is almost the same. This causes extended photobleaching of the dye, together with possible photodamage of the specimen. Moreover, the acquisition of a three-dimensional image of the specimen requires several scans (one for each section), and fluorescence is excited in the whole sample volume during every scan. Photobleaching, together with the low penetration of visible light in biological tissues, makes confocal microscopes unsuitable for in vivo applications or for thick specimens.

This inconvenient is overcome by multiphoton microscopes. Multiphoton microscopes are laser scanning microscopes in which fluorescence is excited by absorption of two or more photons at the same time. Such a process is less probable than single-photon fluorescence, and it takes place only in the focal plane, where the laser light has sufficiently high intensity. The multiphoton microscope is therefore “intrinsically confocal”, without the need of a spatial filter. The wavelength of the excitation laser is in the near infrared. Pulsed lasers are needed to reach the high intensities necessary to multiphoton excitation; typical pulsewidths are near or less than one picosecond.

Since fluorescence emission is located only in the focal plane, photobleaching is restricted to the focal plane as well: the scan of a section of the specimen does not cause photobleaching in other sections. Furthermore, multiphoton absorption bands are wider than single-photon absorption bands, a fact allowing excitation of several different dyes at the same time without changing the wavelength of the incident light. This, together with a greater penetration depth of infrared light in tissues, makes multiphoton microscopy the tool of choice for in vivo applications or for thick specimens.

Another kind of non-linear microscope, the higher harmonics generation microscope, relies on the same building scheme of the multiphoton microscope, but on a different physical principle. In this case, what is detected is the second, third, . . . , n-th harmonics of the incident light generated by the sample. Higher harmonics microscopy allows imaging of complex structures having defined symmetries.

The laser scanning microscopes reviewed so far suffer from high scan times, which makes them unsuitable for applications requiring much higher scanning speeds. This has led during the last years to the development of the so-called real-time confocal microscopes. A popular solution, the so-called Nipkow disk, relies on a spinning grid of pinholes and microlenses. The sample is thus illuminated by several beamlets at the same time. Together with an improvement in scanning speed, photobleaching is also largely decreased. The disadvantage of this kind of microscope is that illumination of the sample is not uniform. Furthermore, it is necessary to use a CCD camera as detector: although high-sensitivity CCD cameras have been greatly improved in recent years, they are much more expensive than a photomultiplier tube at a given transfer rate. Moreover, it is not possible to use time-resolved techniques (such as FLIM, Fluorescence Lifetime Imaging, or FCS, Fluorescence Correlation Spectroscopy) or techniques based on localized photobleaching (such a FRAP, Fluorescence Recovery After Photobleaching).

It is the object of the present invention to provide an apparatus for real-time laser scanning microscopy which overcomes the above limitations. In order to reduce image acquisition times an optical system is disclosed that generates a three-dimensional matrix of focal points inside the sample. Such system is suitable for both fluorescence microscopy and higher harmonics generation microscopy.

### SUMMARY

Apparatus for real-time three-dimensional laser scanning microscopy, where single-photon fluorescence light, multi-photon fluorescence light, and higher order harmonics generated in the sample are detected.

The excitation light is focused into the sample in a three-dimensional matrix of focal points. In the sample plane (xy plane) the separation distance between adjacent focal points is greater than the focal point dimension. The focal points are multiplexed along the optical axis (z axis). The matrix of focal points optically scans the sample along the x and y directions, this scan being extremely fast. Real-time three-dimensional images are obtained directly by a scan in the xy plane only. Furthermore, It is possible to perform time-resolved microscopy (e.g., FCS and FLIM) or photobleaching-based microscopy (e.g., FRAP) over several volumes at the same time.

### BRIEF DESCRIPTION OF THE DRAWINGS

FIG. 1 illustrates the working scheme of the invention.

FIG. 2 illustrates the working scheme of the invention, with “backward” detection.

FIG. 3 illustrates the working scheme of the multispot unit, relative to the first preferred embodiment of the present invention.

FIG. 4 illustrates the working scheme of the multispot unit, relative to the second and fifth preferred embodiments of the present invention.

FIG. 5 illustrates the mechanism of multiplexing of the focal points along the z axis. Objects are not to scale.

FIG. 6 illustrates the working scheme of the detection unit, relative to the first preferred embodiment of the present invention.

FIG. 7 illustrates the working scheme of the detection unit, relative to the second, third, fifth, and sixth preferred embodiments of the present invention.

FIG. 8 illustrates the beam combiner, relative to the second, fourth, fifth, and seventh preferred embodiments of the present invention. Objects are not to scale.

### DETAILED DESCRIPTION OF THE INVENTION

The present invention is an apparatus for real-time three-dimensional laser scanning microscopy, where single-photon fluorescence light, multi-photon fluorescence light, and higher order harmonics generated in the sample are detected.

The laser excitation light is focused inside the sample in a three-dimensional matrix of focal points. In the sample plane (xy plane) the separation distance between adjacent focal points is greater than the focal point dimension. The focal points are multiplexed along the optical axis (z axis). The matrix of focal points optically scans the sample along the x and y directions, this scan being extremely fast. Three-dimensional images are obtained directly by a scan in the xy plane only. Furthermore, it is possible to perform time-resolved microscopy (e.g., FCS and FLIM) or photobleaching-based microscopy (e.g., FRAP) over several volumes at the same time.

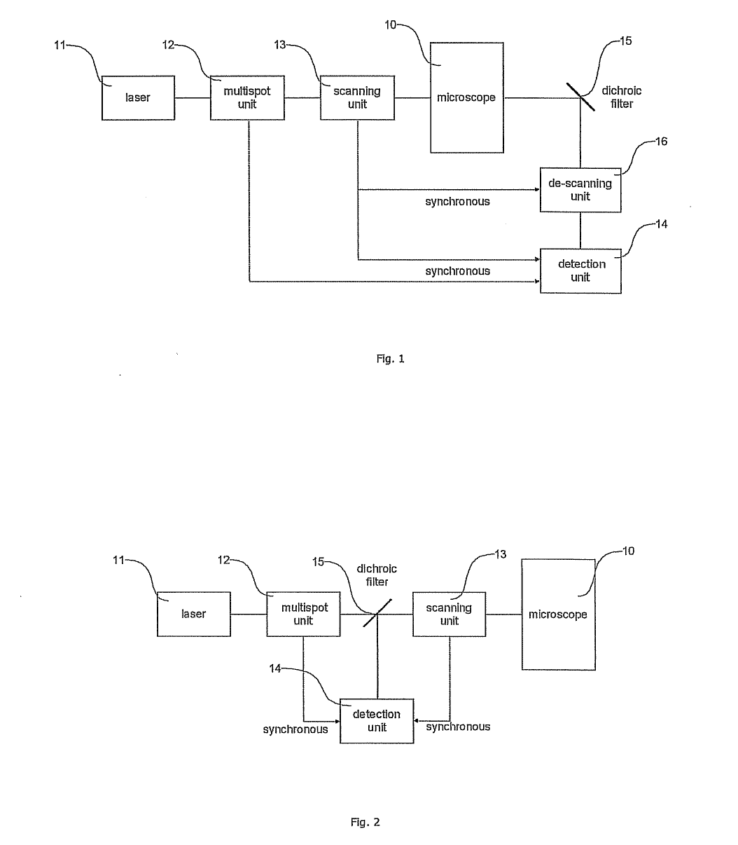

With reference to FIG. 1, the device disclosed by the present invention comprises:
a microscope 10, comprising a stage for the sample, an objective lens aimed at focusing the excitation light inside the sample, and an optional collecting lens aimed at collecting the light emitted by fluorescence or by generation of higher order harmonics. The objective lens and the collecting lens may be the same lens;
a laser source 11;
a multispot unit 12, i.e., an optical system that focuses the excitation laser light inside the sample in a three-dimensional matrix of focal points;
a scanning unit 13, performing the optical scan of the sample in the xy plane;
a detection unit 14;
a dichroic filter 15, separating the optical path of the detected light from that of the excitation laser beam;
an optional de-scanning unit 16.

The first preferred embodiment of the present invention is an apparatus for single-photon fluorescence confocal microscopy. The laser source 11 comprises one or more continuous lasers. The use of more than one laser, or of a laser emitting over several wavelengths, allows the excitation of several different molecules at the same time.

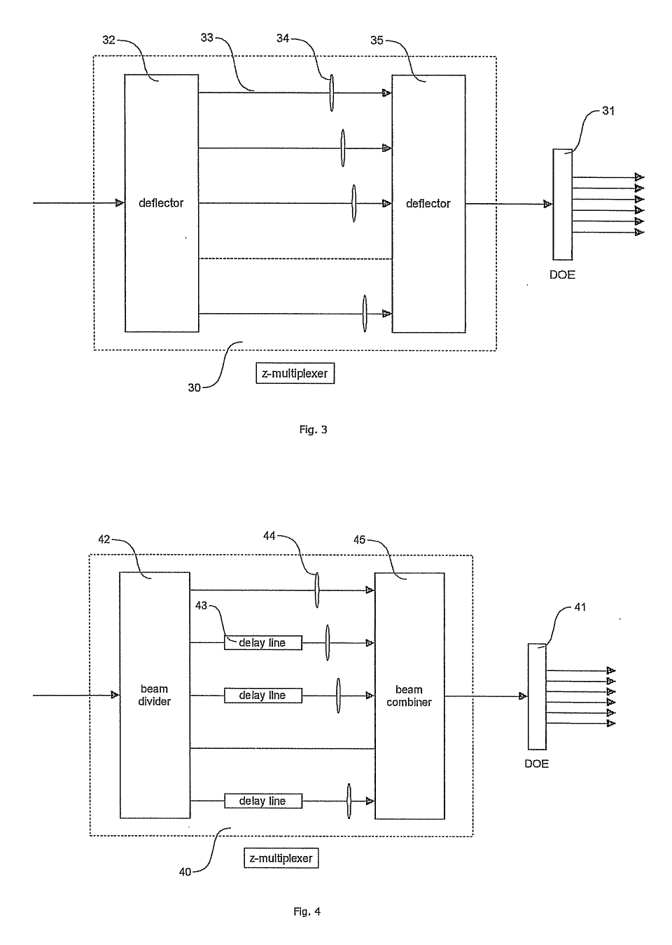

With reference to FIG. 3, the multispot unit 12 comprises a z-multiplexer 30 and a diffractive optics element 31 (from now on referred to as DOE). The z-multiplexer comprises two deflectors and a plurality of lenses. The deflectors are galvanometric mirrors, piezoelectric mirrors, polygonal mirrors, acousto-optical deflectors, or a combination of these elements.

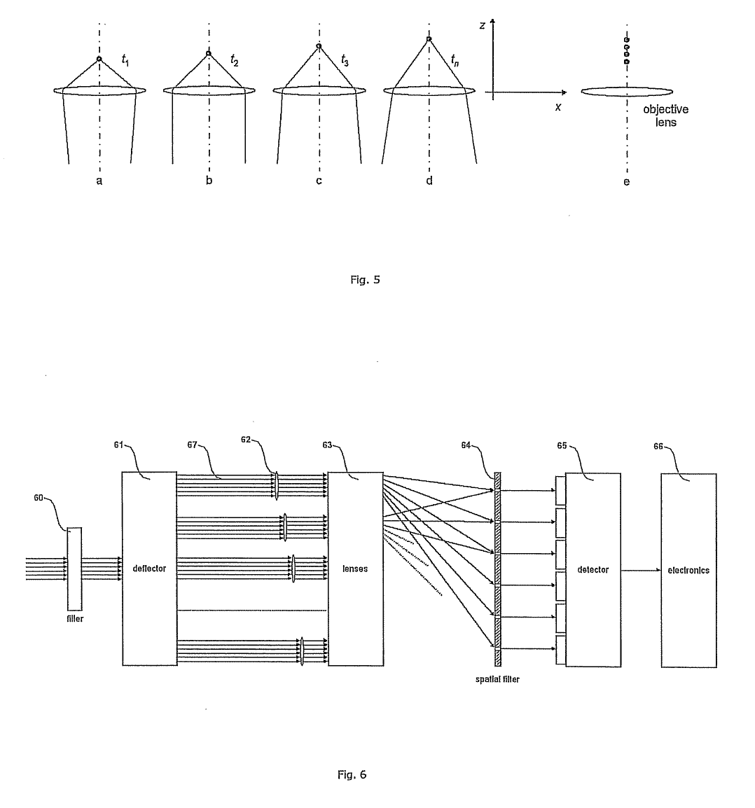

The first deflector 32 deflects the incident laser beam over several optical lines 33, in sequence. Every optical line comprises a plurality of lenses 34, which, together with the objective lens, focus the laser light at a specific depth inside the sample. The depth at which the laser beam is focused is different for every optical line, as illustrated in FIG. 5. The excitation laser light impinges on the objective lens slightly decollimated. The z-multiplexer 30, scanning the laser beam over the optical lines 33, makes such decollimation vary with time, so that the laser light is focused to different depths at subsequent times t₁, t₂, . . . , tₙ. as illustrated in FIG. 5a-d for four points inside the sample along the optical axis. FIG. 5e shows the position of the focal points depicted in FIG. 5a-d. The second deflector 35 deflects the laser light in a mirrorlike fashion with respect to the first, redirecting over the very same optical path the light beams coming from the different optical lines 33. The effect of the z-multiplexing is that of splitting the continuous laser emission into a series of pulses focused at different depths inside the sample.

The DOE 31 splits the incident laser beam into several beamlets. Such beamlets are focused by the objective into a matrix of points in the xy plane of the sample, at the same depth z. The separation distance between such focal points in the xy plane is greater than the dimension of the focal points themselves, thus avoiding interference. Fluorescence from the sample is excited in every such focal point.

The multispot unit 12 has the overall effect of generating inside the sample a three-dimensional matrix of excitation focal points. Such a matrix is obtained by: (a) simultaneous generation of a matrix of focal points in the xy plane; and (b) multiplexing along the z axis. The detection unit 14 is synchronous with the multispot unit, as described further on.

The scanning unit 13 deflects the incident laser beamlets in order for the focal points to perform a complete xy scan of the area under inspection. Such scanning unit 13 is made by galvanometer mirrors, piezoelectric mirrors, polygonal mirrors, acousto-optical deflectors, or a combination of these elements. The detection unit 14 is synchronous with the scanning unit, as described further on.

The dichroic filter 15 separates the optical path of the exciting laser light from that of the fluorescence signal. The fluorescence signal may be collected by the same objective lens focusing the laser excitation light (“backward” detection scheme), or else by the collecting lens placed in front of the objective lens (“forward” detection scheme). In the case of backward detection, the dichroic filter 15 is placed in between the multispot unit 12 and the scanning unit 13, as shown in FIG. 2. In this case the scanning unit 13 works also as de-scanning unit for the fluorescence signal. In the case of forward detection, on the other hand, a de-scanning unit 16 is needed. The de-scanning unit is identical to and deflects the fluorescence signal in a way opposite and synchronous to the scanning unit 13

With reference to FIG. 6, the detection unit 14 comprises an optional optical filter 60, a deflector 61, a plurality of compensating optics 62, a plurality of lenses 63, a spatial filter 64, a detector 65, and detection electronics 66.

The optical filter 60 selects the optical bandwidth of the fluorescence signal to be detected. It acts also as blocking filter for the scattered laser light that may pass through the dichroic filter 15.

The spatial filter 64 is located before the detector, in a plane conjugate to the plane of the sample. It is constituted of a photolithographic mask over which a matrix of points has been impressed, each point corresponding to a focal excitation point generated inside the sample by the DOE 31. The photolithographic mask is transparent at such points, being opaque over the rest of its surface.

Before the spatial filter 64, a deflector 61 deflects the fluorescence signal in sequence over different optical lines 67, synchronously with the z-multiplexing performed by the multispot unit 12. Such optical lines 67 correspond to those 33 of the z-multiplexer of FIG. 3: i.e., every optical line 67 corresponds to a different depth at which the excitation laser beam is focused inside the sample. The fluorescence signal collected from the entire excitation volume is deflected over the optical lines 67. Considering only the contribution coming from the focal plane of the exciting laser beam, the fluorescence light is slightly decollimated because such plane is slightly shifted from the objective lens focal plane, as in FIG. 5. On every optical line 67 a plurality of compensating optics 62 corrects for such decollimation. In the case that the deflector 61 is an acousto-optical deflector, the compensating optics provide also a correction for the spatial dispersion brought in by the acousto-optical deflector. After such correction, the now collimated fluorescence signal is focused by a plurality of lenses 63 on the spatial filter 64, where it forms an image of the xy matrix of focal points generated by the DOE 31.

The detector 65 is a matrix of photomultiplier tubes, one for every excitation focal point generated inside the sample by the DOE 31. The use of a matrix of photomultiplier tubes in a de-scanned scheme allows, for every focal point generated inside the sample by the DOE, to perform a scan over an area larger than the area strictly necessary. This in turn allows to discard the scan borders, where the scanning system may show non-linearities that compromise the image fidelity. Moreover, a matrix of photomultiplier tubes in a de-scanning scheme allows, for every point of the scan, a time-resolved analysis of the fluorescence signal, thence the application of multi-area FCS microscopy.

The detection electronics 66 are synchronous with the z-multiplexer 30 and with the scanning unit 13: every time the excitation beamlets move to the nearby pixel along z or xy, the electronics read the value of the intensity of the fluorescence signal on the detector. For every photomultiplier tube, the electronics comprise an integrator and an analog/digital converter. The signal output by the converter is stored on a digital memory. Stored data are subsequently processed by a computer as digital images.

The detection units 14 may be more than one, for the simultaneous detection of the fluorescence signal over several wavelengths.

In the detection unit, spatial dispersion of the fluorescence light may be expressly induced, in order to perform multispectral detection. This is obtained by inserting a dispersing prism between the deflector 61 and the spatial filter 64. By translating the spatial filter one can select the window of detected wavelengths.

The second preferred embodiment of the present invention is a multiphoton fluorescence microscope. The laser source 11 is in this case a pulsed laser. With reference to FIG. 4, the multispot unit 12 comprises a z-multiplexer 40 and a diffractive optics DOE 41. The z-multiplexer 40 comprises, in turn, a beam divider 42, a plurality of delay lines 43, a plurality of lenses 44, and a beam combiner 45.

The beam divider 42 comprises a plurality of cascaded beamsplitters, or by a diffractive optics. It splits a single laser pulse over several optical lines.

Every optical line comprises a delay line 43 and a plurality of lenses 44 which, together with the objective lens, focus the laser light at a specific depth inside the sample. The depth at which the laser beam is focused is different for every optical line, as illustrated in FIG. 5. The excitation laser light impinges on the objective lens slightly decollimated. The z-multiplexer 40, scanning the laser beam over the optical lines, makes such decollimation vary with time, so that the laser light is focused to different depths at subsequent times t₁, t₂, . . . , tₙ. as illustrated in FIG. 5a-d for four points inside the sample along the optical axis. FIG. 5e shows the position of the focal points depicted in FIG. 5a-d.

In every delay line 43 the laser light covers a different optical length: thus, from the same laser pulse several pulses are obtained which are focused at subsequent times at different depths inside the sample. The delay between two pulses coming from two consecutive delay lines is greater than the typical fluorescence emission times. In this way, fluorescence emission from a point in the sample at depth z+Δz is excited when the fluorescence emission from the point at depth z is already decayed. The overall delay time of the last delay line is less than the pulse repetition period of the laser source.

The beam combiner 45 comprises a plurality of mirrors 80, tilted in such a way as to direct towards the same point all beams coming from the different optical lines. Such a point is located on a plane conjugate to the objective back focal plane, as depicted in FIG. 8. The DOE 41 is located in such conjugate plane.

Beams coming from different optical lines arrive at the objective back focal plane at an angle between them. In the sample, focal points corresponding to beams coming from different optical lines have different axial (z) and radial positions as well. The beam combiner mirrors 80 are tilted in such a way as to make the radial shift between such focal points small, in comparison to the area under investigation. This small shift can be corrected for during image processing.

The effect of the z-multiplexing is that of splitting a single pulse from the laser into a series of pulses focused at different depths inside the sample.

The DOE 41 splits the incident laser beam into several beamlets. Such beamlets are focused by the objective into a matrix of points in the xy plane of the sample, at the same depth z. The separation distance between such focal points in the xy plane is greater than the dimension of the focal points themselves, thus avoiding interference. Fluorescence from the sample is excited in every such focal point.

The multispot unit 12 has the overall effect of generating inside the sample a three-dimensional matrix of excitation focal points. Such a matrix is obtained by: (a) simultaneous generation of a matrix of focal points in the xy plane; and (b) multiplexing along the z axis. The detection unit 14 is synchronous with the multispot unit, as described further on.

The scanning unit 13 deflects the incident laser beamlets in order for the focal points to perform a complete xy scan of the area under inspection. Such scanning unit 13 is made by galvanometer mirrors, piezoelectric mirrors, polygonal mirrors, acousto-optical deflectors, or a combination of these elements. The detection unit 14 is synchronous with the scanning unit, as described further on.

The dichroic filter 15 separates the optical path of the exciting laser light from that of the multiphoton fluorescence signal. The fluorescence signal may be collected by the same objective lens focusing the laser excitation light (“backward” detection scheme), or else by the collecting lens placed in front of the objective lens (“forward” detection scheme). In the case of backward detection, the dichroic filter 15 is placed in between the multispot unit 12 and the scanning unit 13, as shown in FIG. 2. In this case the scanning unit 13 works also as de-scanning unit for the fluorescence signal. In the case of forward detection, on the other hand, a de-scanning unit 16 is needed. The de-scanning unit is identical to and deflects the fluorescence signal in a way opposite and synchronous to the scanning unit 13.

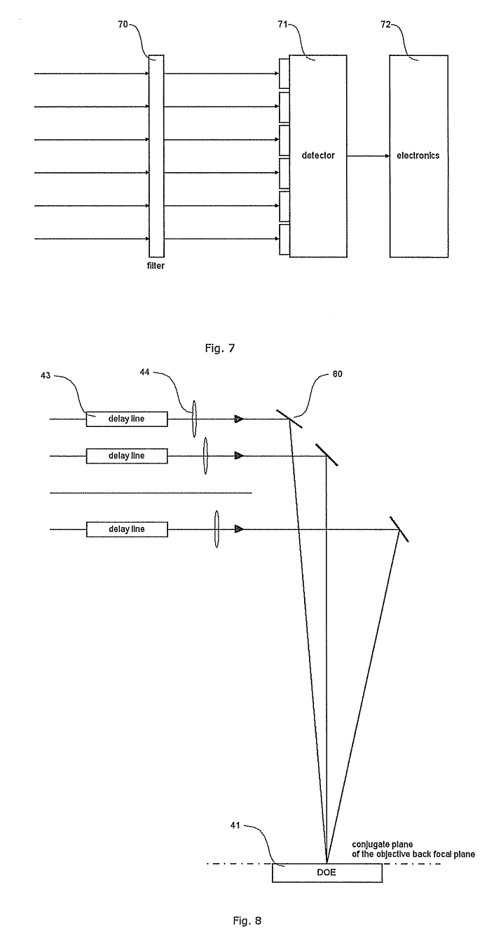

With reference to FIG. 7, in this embodiment the detection unit 14 comprises an optional optical filter 70, a detector 71, and detection electronics 72.

The optical filter 70 selects the optical bandwidth of the fluorescence signal to be detected. It acts also as blocking filter for the scattered laser light that may pass through the dichroic filter 15.

The detector 71 is a matrix of photomultiplier tubes, one for every excitation focal point generated inside the sample by the DOE 41. The use of a matrix of photomultiplier tubes in a de-scanned scheme allows, for every focal point generated inside the sample by the DOE, to perform a scan over an area larger than the area strictly necessary. This in turn allows to discard the scan borders, where the scanning system may show non-linearities that compromise image fidelity. Moreover, the matrix of photomultiplier tubes in a de-scanning scheme allows, for every point of the scan, a time-resolved analysis of the fluorescence signal, thence the application of multi-area FCS and FLIM microscopy.

The detection electronics 72 are synchronous with the z-multiplexer 40 and with the scanning unit 13: every time the excitation beamlets move to the nearby pixel along z or xy, the electronics read the value of the intensity of the fluorescence signal on the detector. For every photomultiplier tube, the electronics comprise an integrator and an analog/digital converter. The signal output by the converter is stored on a digital memory. Stored data are subsequently processed by a computer as digital images. The pixel readout may be done with a time-gated mechanism, in order to have fluorescence signal resolved in time.

The detection units 14 may be more than one, for the simultaneous detection of the fluorescence signal over several wavelengths.

The third preferred embodiment of the present invention is a multiphoton microscope where, with respect to the second preferred embodiment, the multispot unit 12 comprises the sole DOE 41. A two-dimensional matrix of excitation focal points is generated inside the sample, on the xy plane only.

The fourth preferred embodiment of the present invention is a multiphoton microscope where, with respect to the second preferred embodiment, the multispot unit 12 comprises the sole z-multiplexer 40. A unidimensional matrix of excitation focal points is generated inside the sample, along the z axis only. The detector 71 is in this embodiment a single photomultiplier tube, or an avalanche photodiode.

The fifth preferred embodiment of the present invention is a higher harmonics generation microscope. This embodiment is based on the same scheme of the multiphoton microscope of the second preferred embodiment, except for the fact that the detected signal is in this case the second, third, . . . , n-th harmonics of the incident laser light.

In this preferred embodiment, the optical filter 70 located before the detector selects a narrow band of frequencies around a frequency which is twofold, threefold, . . . , n-fold the laser frequency.

The detection units 14 may be more than one for the simultaneous detection of the higher order harmonics and the multiphoton fluorescence signal.

The sixth preferred embodiment is a higher harmonics generation microscope in which, in comparison to the fifth preferred embodiment, the multispot unit 12 comprises the sole DOE 41. A two-dimensional matrix of excitation focal points is generated inside the sample, on the xy plane only.

The seventh preferred embodiment of the present invention is a higher harmonics generation microscope where, with respect to the fifth preferred embodiment, the multispot unit 12 comprises the sole z-multiplexer 40. A unidimensional matrix of excitation focal points is generated inside the sample, along the z axis only. The detector 71 is in this embodiment a single photomultiplier tube, or an avalanche photodiode.

1. A device for laser scanning microscopy, comprising: at least one microscope, at least one laser source, at least one multispot unit, at least one dichroic filter, at least one scanning unit, at least one detection unit, wherein said multispot unit comprises a diffractive optics element DOE.

2. A device according to claim 1, wherein said scanning unit comprises a plurality of elements chosen in the group comprising: galvanometric mirrors, piezoelectric mirrors, polygonal mirrors, acousto-optical deflectors, or a combination of these elements.

3. A device according to claim 1, wherein said dichroic filter is placed in between said multispot unit and said scanning unit.

4. A device according to claim 1 comprising a de-scanning unit.

5. A device according to claim 4, wherein a suitable collecting lens is placed in front of the objective lens of said microscope in order to collect the light emitted by the sample.

6. A device according to claim 4, wherein said dichroic filter is placed in between said microscope and said de-scanning unit.

7. A device according to claim 4, wherein said de-scanning unit is identical to and acts in an opposite and synchronous way to said scanning unit.

8. A device according to claim 1, wherein said laser source comprises one or more continuous lasers.

9. A device according to claim 1, wherein said multispot unit further comprises a z-multiplexer.

10. A device according to claim 9, wherein said z-multiplexer comprises two deflectors and a plurality of lenses.

11. A device according to claim 10, wherein said deflectors are chosen in the group comprising: galvanometric mirrors, piezoelectric mirrors, polygonal mirrors, acousto-optical deflectors, or a combination of these elements.

12. A device according to claim 9, wherein said detection unit comprises: at least one optional optical filter, at least one deflector, a plurality of lenses, at least one optional dispersing prism, at least one spatial filter, at least one detector, and detection electronics.

13. A device according to claim 12, wherein said deflector is chosen in the group comprising: galvanometric mirrors, piezoelectric mirrors, polygonal mirrors, acousto-optical deflectors.

14. A device according to claim 12, wherein said spatial filter is placed before said detector, in a plane conjugate to the plane of the sample.

15. A device according to claim 14, wherein said spatial filter comprises a photolithographic mask.

16. A device according to claim 12, wherein said detector comprises a matrix of photomultiplier tubes, each one corresponding to an excitation focal point generated inside the sample by said diffractive optics element DOE.

17. A device according to claim 12, wherein said detection electronics is synchronous with said multispot unit and with said scanning unit, in order to acquire the fluorescence signal point by point.

18. A device according to claim 12, wherein said detection electronics comprises at least one integrator and at least one analog/digital converter for every photomultiplier tube composing said detector, and at least one unit of digital memory.

19. A device according to claim 12, wherein said dispersing prism causes spatial dispersion of the fluorescence light, in order to perform multispectral detection when combined with said spatial filter.

20. A device according to claim 1, wherein said laser source comprises a pulsed laser.

21. A device according to claim 20, wherein said multispot unit further comprises a z-multiplexer.

22. A device according to claim 21, wherein said z-multiplexer comprises at least one beam divider, a plurality of delay lines, a plurality of lenses, at least one beam combiner.

23. A device according to claim 22, wherein said beam divider comprises a plurality of beamsplitters.

24. A device according to claim 22, wherein said beam divider comprises a diffractive optics.

25. A device according to claim 22, wherein said beam combiner comprises a plurality of mirrors.

26. A device according to claim 22, wherein said detection unit comprises: at least one optional optical filter, at least one detector, and detection electronics.

27. A device according to claim 26, wherein said detector comprises a matrix of photomultiplier tubes, each one corresponding to an excitation focal point generated inside the sample by said diffractive optics element DOE.

28. A device according to claim 26, wherein said detection electronics is synchronous with said multispot unit and with said scanning unit, in order to acquire the fluorescence signal point by point.

29. A device according to claim 26, wherein said detections electronics comprises at least one integrator and at least one analog/digital converter for every photomultiplier tube composing said detector, and at least one unit of digital memory.

30. A device according to claim 26, wherein said optical filter selects only the second, third, n-th harmonics of the incident laser light.
